(19) United States
(12) Patent Application Publication
(10) Pub. No.: US 2016/0054892 A1
(43) Pub. Date: Feb. 25, 2016

(54) WEARABLE DEVICE FOR DISPLAYING A SCHEDULE, METHOD OF OPERATING THE SAME, AND STORAGE MEDIUM

(71) Applicant: SAMSUNG ELECTRONICS CO., LTD., SUWON-SI (KR)

(72) Inventors: YOON YOUNG KIM, HWASEONG-SI (KR); JANG WON LEE, SEONGNAM-SI (KR); KI HYOUN KWON, HWASEONG-SI (KR); SOOK HEE SUNG, SUWON-SI (KR); JUN HO LEE, HWASEONG-SI (KR); SUNG HOON SON, SUWON-SI (KR); JEROME HAN, DAEJEON (KR)

(21) Appl. No.: 14/791,281

(22) Filed: Jul. 3, 2015

(30) Foreign Application Priority Data
Aug. 21, 2014 (KR) 10-2014-0109220

(51) Int. Cl. G06F 3/0481; G06F 3/0484; G06F 3/0482

(52) U.S. Cl. CPC G06F 3/04817; G06F 3/0482; G06F 3/04847

(57) ABSTRACT

A method is for displaying a schedule in a wearable device is provided. The method includes displaying a watch screen on a display of the wearable device and displaying an event display icon corresponding to a scheduled event on the watch screen.

### CROSS-REFERENCE TO RELATED APPLICATIONS

A claim of priority under 35 U.S.C. § 119(a) is made to Korean Patent Application No. 10-2014-0109220 filed on Aug. 21, 2014, the disclosure of which is hereby incorporated by reference in its entirety.

### BACKGROUND

Embodiments of the inventive concept relate to wearable devices, and more particularly, to devices for displaying a schedule on a watch screen displayed on a display of a wearable device, a method of operating the same, and a storage medium.

With the development of information technology (IT), wearable devices have been introduced. Wearable devices usually include components necessary for minimum operations in order to minimize discomfort when they are worn and maximize a usage time. Since wearable devices are restricted in size, a display thereof tends to be relatively small. Accordingly, wearable devices have much fewer functions than portable terminals such as smart phones. However, since wearable devices can always be worn by users, they could provide more convenience than portable terminals. For instance, the present time of day or simple messages can be easily checked in a smart watch.

Conventionally, users usually check schedules on portable terminals. To check the schedules, the users need to execute a schedule software module in portable terminals. It is cumbersome and inconvenient for the users to execute the schedule software module and the schedules cannot be checked intuitively. Moreover, it is hard to check the schedules during another task such as a call.

### SUMMARY

Some embodiments of the inventive concept provide a wearable device for allowing a user to check a schedule and enter a schedule software module quickly and intuitively, a method of operating the same, and a storage medium.

According to some embodiments of the inventive concept, there is provided a method of displaying a schedule including a scheduled event in a wearable device. The method includes displaying a watch screen on a display of the wearable device and displaying an event display icon corresponding to the scheduled event on the watch screen. The method may further include displaying a description of the scheduled event corresponding to the event display icon on the display when the event display icon is selected by a user input.

The watch screen may be an analog watch screen and the event display icon may be displayed at a time location on the analog watch screen that corresponds to a time of the scheduled event. As an alternative, the event display icon may be displayed on the analog watch screen in a different shape according to whether the time of the scheduled event is in the morning or afternoon. As another alternative, the event display icon may be displayed inside of the analog watch screen when the time of the scheduled event corresponding to the event display icon is one among a morning time and an afternoon time, and may be displayed outside of the analog watch screen when the time of the scheduled event is the other than the morning time and the afternoon time.

The event display icon may be displayed as a first type icon on the watch screen when the scheduled event corresponding to the event display icon is in a first category and may be displayed as a second type icon on the watch screen when the scheduled event corresponding to the event display icon is in a second category.

The schedule may include a plurality of scheduled events, and displaying the event display icon on the watch screen may include displaying a corresponding plurality of event display icons on the watch screen, and displaying a pop-up window when at least one among a plurality of adjacent event display icons among the plurality of event display icons is selected by a user input and displaying the adjacent event display icons in the pop-up window. The method may further include displaying a description of a scheduled event corresponding to an event display icon which has been selected by a user input among the adjacent event display icons displayed in the pop-up window.

The user input may be a touch input using a touch screen. When a touch point is moved by a user, an event display icon located at the touch point that has been moved may be displayed in the pop-up window. The method may further include deleting the event display icon displayed on the watch screen when a present time passes a time of the event corresponding to the event display icon.

The displaying the event display icon on the watch screen may include displaying first event display icons indicating first events including scheduled events having times within a reference time.

The schedule may be received from a portable terminal which can communicate with the wearable device. Alternatively, the schedule may be created using a schedule software module installed in the wearable device.

The method may further include performing a notification operation using the wearable device when a time of the event is within a reference time range.

According to other embodiments of the inventive concept, there is provided a wearable device including a display configured to display a watch screen including an event display icon indicating a scheduled event, a memory configured to store a schedule including the schedule event and the watch screen, and a processor configured to control operations of the display and the memory to display the event display icon on the watch screen and display a description of the scheduled event corresponding to the event display icon on the display when the event display icon is selected by a user input.

According to further embodiments of the inventive concept, there is provided a computer readable storage medium for storing a computer program for executing the above-described methods.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a schematic block diagram of a wearable device according to some embodiments of the inventive concept;

FIGS. 2 and 3 are diagrams of analog watch screen displayed on a display in the wearable device illustrated in FIG. 1 according to different embodiments of the inventive concept;

FIG. 4 is a diagram of a digital watch screen displayed on the display in the wearable device illustrated in FIG. 1 according to some embodiments of the inventive concept;

FIGS. 5 and 6 are diagrams showing embodiments in which an event display icon on a watch screen is selected using a user input and an event corresponding to the selected event display icon is displayed;

FIG. 7A, 7B, 8A, 8B and 9 are diagrams illustrating a method of displaying an event corresponding to an event display icon that a user wants to select when adjacent event display icons are selected by a user input at a time according to some embodiments of the inventive concept;

FIGS. 10 and 11 are diagrams of embodiments in which an event display icon belonging to a morning schedule and an event display icon belonging to an afternoon schedule are displayed to be distinguished from each other;

FIGS. 12 and 13 are diagrams of different displays of event display icons according to the categories of events according to some embodiments of the inventive concept;

FIGS. 14 and 15 are diagrams of embodiments in which event display icons are updated over time;

FIGS. 16, 17, 18 and 19 are diagrams of a schedule graphical user interface (GUI) that displays events according to some embodiments of the inventive concept;

FIGS. 20, 21 and 22 are diagrams illustrating an event creation process in a wearable device according to some embodiments of the inventive concept;

FIG. 23 is an operational flowchart associated with the embodiments illustrated in FIGS. 5 and 6;

FIGS. 24 and 25 are operational flowcharts associated with the embodiments illustrated in FIGS. 7 through 9;

FIG. 26 is an operational flowchart associated with the embodiments illustrated in FIGS. 14 and 15; and

FIG. 27 is a diagram of a system, which performs a method of displaying a schedule in a wearable device, according to some embodiments of the inventive concept.

### DETAILED DESCRIPTION OF THE EMBODIMENTS

The inventive concept now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

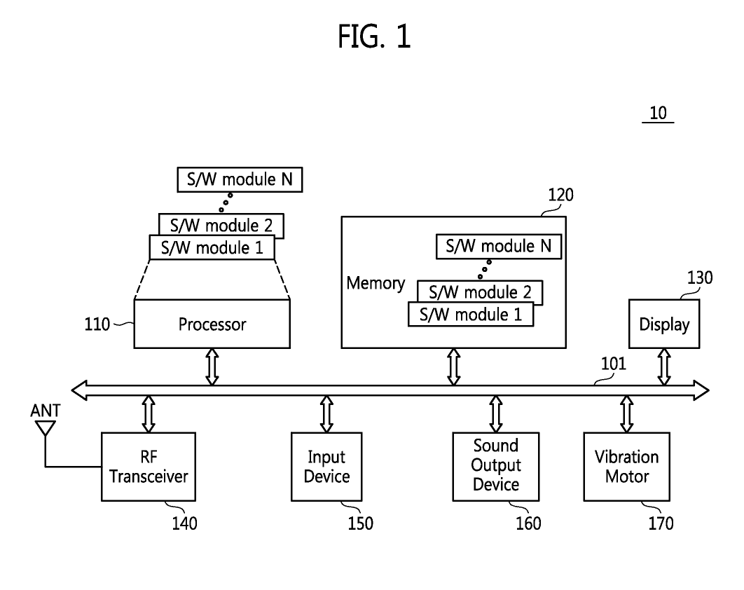

FIG. 1 is a schematic block diagram of a wearable device 10 according to some embodiments of the inventive concept. The wearable device 10 includes a processor 110, a memory 120, a display (or a display device) 130, a radio frequency (RF) transceiver 140, and an input device 150.

The wearable device 10 is an electronic device, such as a smart watch or smart glasses, which a user can wear. In the embodiments of the inventive concept, the wearable device 10 is a smart watch. However, the technical features of the inventive concept are not restricted to a smart watch and may apply to other types of wearable devices.

The processor 110 may control the operation of at least one of elements 120, 130, 140, and 150 of the wearable device 10 through a bus 101. To control the operation of each of the elements 120, 130, 140, and 150, the processor 110 may execute a predetermined software module among a plurality of software modules (or application programs) S/W module1 through S/W moduleN stored in the memory 120, where N is a natural number.

The processor 110 may display a watch screen on the display 130 of the wearable device 10 using a software module (e.g., S/W module1) related with a watch screen and may display a schedule on the display 130 using a schedule software module (e.g., S/W module2). The processor 110 may be an integrated circuit (IC), an application processor (AP), a mobile AP, or a central processing unit (CPU) but is not limited thereto.

The memory 120 may store instructions necessary for the operation of the processor 110, the software modules (or application programs) S/W module1 through S/W moduleN, and/or various data (e.g., schedules). The memory 120 may operate as an operation memory of the processor 110 and may be implemented as a cache, dynamic random access memory (DRAM), or static RAM (SRAM). The memory 120 may store a first software module (e.g., S/W module1) related with a watch screen and a second software module (e.g., S/W module2) related with a schedule. The first software module S/W module1 and the second software module S/W module2 may be implemented in a single application program or in different programs, respectively.

In other embodiments, the memory 120 may be implemented as a flash-base memory such as a multimedia card (MMC), an embedded MMC (eMMC), a universal flash storage (UFS), or a solid state drive (SSD). The memory 120 may be considered as a group of at least one memory.

The display 130 may display the watch screen and the schedule together according to the control of the processor 110. The display 130 may be implemented as a thin film transistor-liquid crystal display (TFT-LCD), light emitting diode (LED) display, organic LED (OLED) display, active-matrix OLED (AMOLED) display, or flexible display.

When a time of a scheduled event is within a reference time range, the display 130 may perform a notification operation according to the control of the processor 110. The notification operation may be changing the brightness of a screen or flickering, but it is not restricted thereto.

The RF transceiver (or a wireless communication module) 140 may be used to transfer various data between the wearable device 10 and a portable terminal or a server. The data may be about a schedule. The RF transceiver 140 may communicate with the portable terminal using a wireless communication protocol such as Bluetooth, near field communication (NFC), Wi-Fi, long term evolution (LTE), or wideband code division multiple access (W-CDMA). The portable terminal may be a smart phone, a tablet personal computer (PC), a mobile internet device (MID), an internet of things (IoT) device, or an internet of everything (IoE) device.

A user may enter a user input for controlling the operation of the wearable device 10 through the input device 150. The input device 150 may include a touch screen, a microphone, a physical button, and/or a physical dial, but the inventive concept is not restricted to the current embodiments. In other embodiments, the input device 150 may be a user interface.

The wearable device 10 may also include a sound output device 160 and/or a vibration motor 170. The sound output device 160 and/or the vibration motor 170 may output notification sound and/or vibration according to the control of the processor 110 when a scheduled time is within a reference time range (e.g., 20 minutes before the scheduled time). The sound output device 160 may be a speaker or an earphone output port. The vibration motor 170 may be a linear vibration motor or a surface mount device (SMD)-type coin vibration motor. However, the inventive concept is not restricted to these examples.

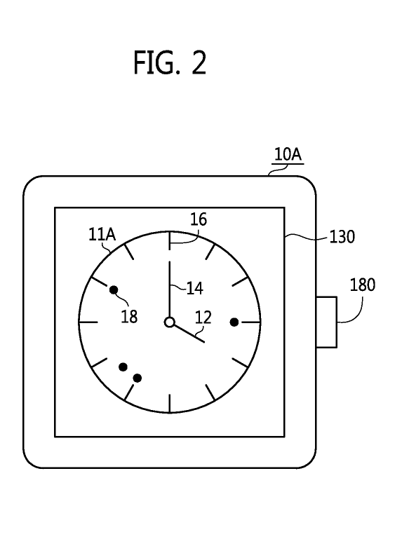

FIG. 2 is a diagram of an analog watch screen 11A displayed on the display 130 in the wearable device 10 illustrated in FIG. 1 according to some embodiments of the inventive concept. Referring to FIGS. 1 and 2, the analog watch screen 11A is a depiction of the face of an analog watch showing a current time, and may be displayed on the display 130 of a wearable device 10A. The analog watch screen 11A may include an hour hand 12, a minute hand 14, and graduations 16. The analog watch screen 11A may also include a second hand (not shown) or numerals (not shown) corresponding to the graduations 16 in other embodiments. In other words, elements may freely be modified according to the design of the analog watch screen 11A.

The hour hand 12 may indicate the hour of the present time of day and the minute hand 14 may indicate the minutes of the present time. The hour hand 12 may be shorter than the minute hand 14. The graduations 16 may be arranged at a reference distance from the center of the analog watch screen 11A. The graduations 16 may correspond to hours, minutes, and/or seconds. At least one event display icon 18 may be displayed on the analog watch screen 11A. Each event display icon 18 may correspond to a certain scheduled event. For instance, the event display icon 18 may be displayed near (inside or outside of the analog watch screen 11A) a graduation 16 corresponding to the start time of a scheduled event, but the inventive concept is not restricted to the current embodiments.

Referring to FIG. 2, event display icons 18 are displayed at three, seven, seven-thirty, and ten on the analog watch screen 11A in the morning. In other words, as shown in FIG. 2, a user can intuitively perceive that the start times of the scheduled events stored in the memory 120 of the wearable device 10A are three, seven, seven-thirty, and ten in the morning.

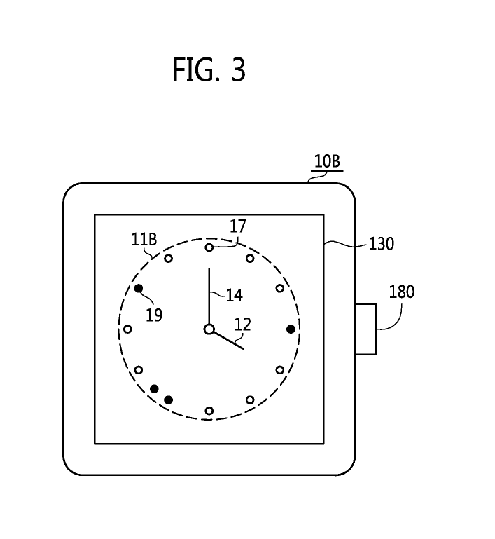

FIG. 3 is a diagram of an analog watch screen 11B displayed on the display 130 in the wearable device 10 illustrated in FIG. 1 according to other embodiments of the inventive concept. Referring to FIGS. 1 and 3, the analog watch screen 11B may be displayed on the display 130 of a wearable device 10B. The analog watch screen 11B includes a circular symbol 17. As described in FIG. 2, the elements 12 and 14 of the analog watch screen 11B may be modified according to embodiments.

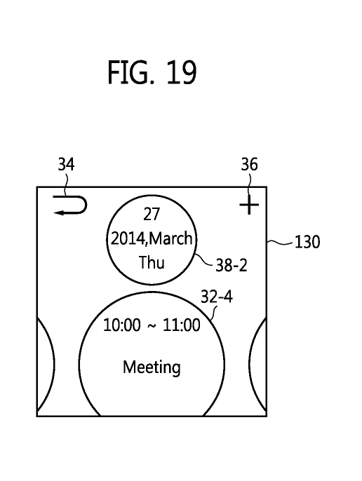

The circular symbol 17 may correspond to a graduation 16 shown in FIG. 2. Event display icons 19 illustrated in FIG. 19 is substantially the same as or similar to the event display icons 18 illustrated in FIG. 2. Thus, the detailed descriptions of the event display icons 19 will be omitted.

The event display icons 18 or 19 illustrated in FIG. 2 or 3 are represented with circles or dots, but the shape of the event display icons 18 or 19 may vary with embodiments. Although the wearable devices 10A and 10B (collectively denoted by numeral 10) and the display 130 are rectangular in the embodiments illustrated in FIGS. 2 and 3, the shape of the wearable devices 10A and 10B and the display 130 may vary with embodiments.

As shown in FIGS. 2 and 3, the wearable devices 10A and 10B may also include a physical button or dial 180. The physical button 180 may function as the input device 150 illustrated in FIG. 1. Although the physical button 180 is placed on the right of the display 130 in the embodiments illustrated in FIGS. 2 and 3, the position of the physical button 180 may vary with embodiments.

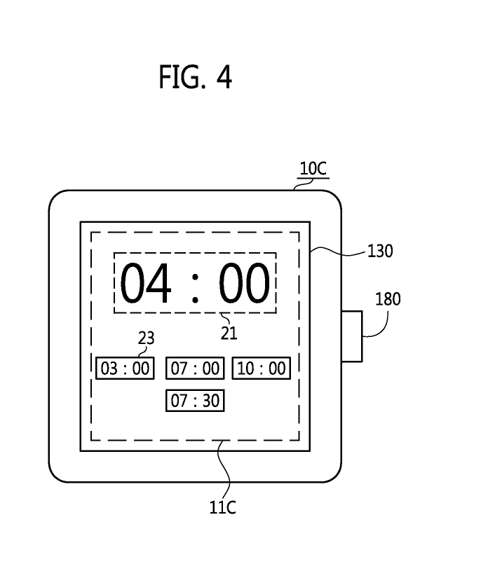

FIG. 4 is a diagram of a digital watch screen 11C displayed on the display 130 in the wearable device 10 illustrated in FIG. 1 according to some embodiments of the inventive concept. Referring to FIGS. 1 and 4, the digital watch screen 11C is displayed on the display 130 of a wearable device 10C and may include a digital watch 21. The digital watch 21 may display the present time of day on the display 130 in a digital watch format, which may be a 12-hour format or 24-hour format.

One or more event display icons 23 may be displayed on the digital watch screen 11C. Each of the event display icons 23 corresponds to a certain scheduled event. The event display icons 23 may be displayed below the digital watch 21, but the position of the event display icons 23 may vary with embodiments.

The event display icons 23 may be arranged in order of start times of scheduled events. As shown in FIG. 4, an event display icon 23 corresponding to a scheduled event with an earlier start time may be placed on the left. When schedule events start at the same hour and different minutes, the scheduled events may be displayed at similar positions. As shown in FIG. 4, each of the event display icons 23 may be displayed including the start time of a scheduled event.

The wearable device 10C may also include the physical button (or dial) 180. The physical button 180 may function as the input device 150 illustrated in FIG. 1.

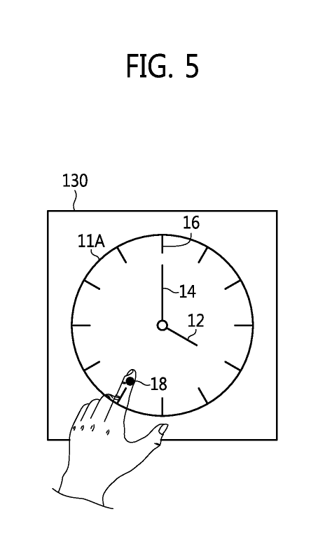

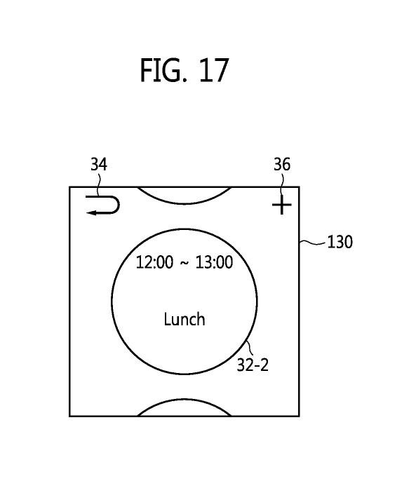

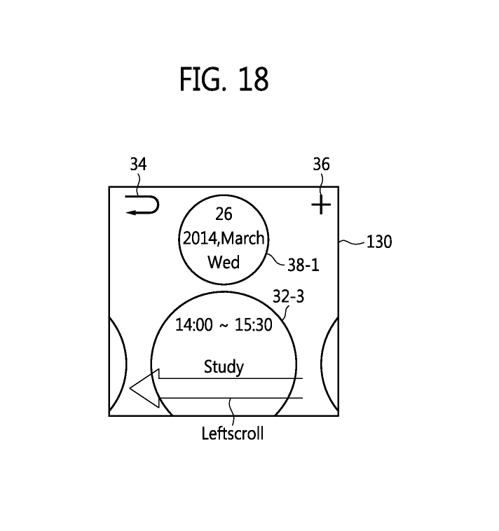

The body of the wearable device 10 is omitted in FIGS. 5 through 22 for convenience' sake in the description. Although the operations of an analog watch screen are illustrated in FIGS. 5 through 22, the technical ideas of the inventive concept is not restricted to the shape of a watch screen.

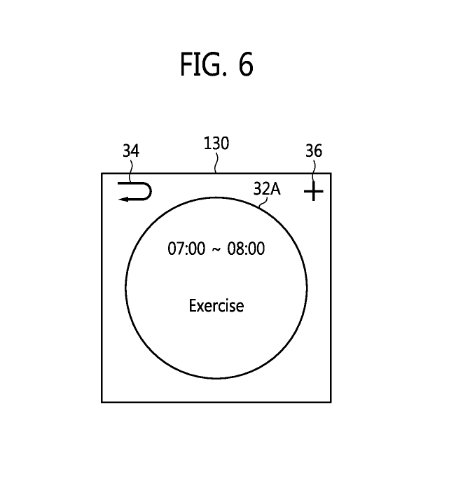

FIGS. 5 and 6 are diagrams showing embodiments in which an event display icon on a watch screen is selected using a user input and an scheduled event corresponding to the selected event display icon is displayed on the display 130. Referring to FIGS. 1, 2, and 5, an event display icon 18 may be selected by a user input (or a user's choice). FIG. 5 shows embodiments in which the event display icon 18 is selected by a touch input.

A user may generate an input signal for selecting the event display icon 18 using the input device 150. The processor 110 may process an operation of selecting the event display icon 18 based on the input signal. The user input may be a touch input using a touch screen, an input using the physical button 180, and/or a voice input using a microphone.

Referring to FIGS. 1, 5, and 6, when the event display icon 18 is selected by the user input, the second software module S/W module2 related with a schedule may be executed by the processor 110 to display a schedule graphical user interface (GUI) including a scheduled event corresponding to the event display icon 18 on the display 130. The schedule GUI includes a schedule display GUI 32A displaying a scheduled event and may also include a return GUI 34 and/or an additional event creation GUI 36.

The schedule display GUI 32A may include a description of the scheduled event. The description may, for example, include detailed information about a scheduled event. The detailed information may include the start and end times, title, description, and/or category of the scheduled event. As shown in FIG. 6, the detailed information includes “exercise from 7 am to 8 am”. When the return GUI 34 is selected by a user input (e.g., a touch), a previous screen, i.e., the watch screen 11A illustrated in FIG. 5 comes back.

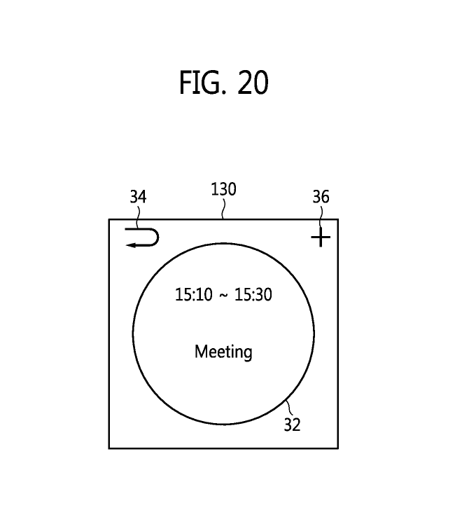

When the additional event creation GUI 36 is selected by a user input (e.g., a touch), the wearable device 10 prepares to create a new scheduled event in the schedule. The creation of a new scheduled event will be described in detail with reference to FIGS. 20 through 22 later. The elements 32A, 34, and 36 illustrated in FIG. 6 may be changed in various ways according to the design of a schedule GUI.

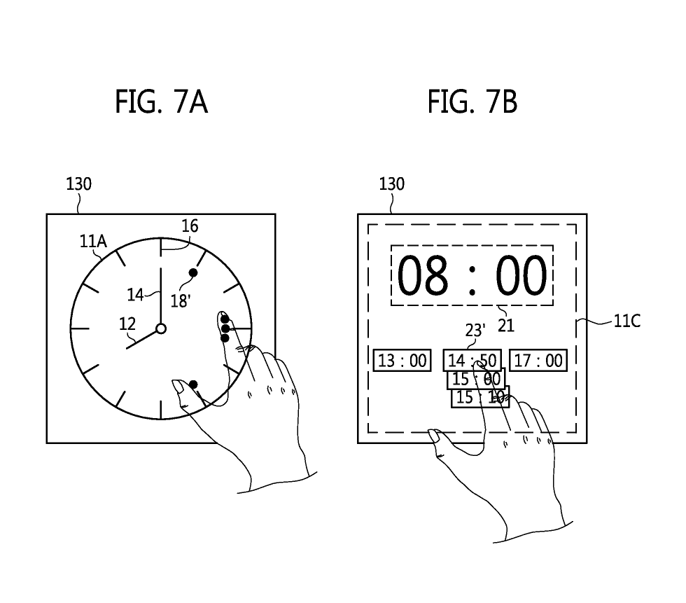

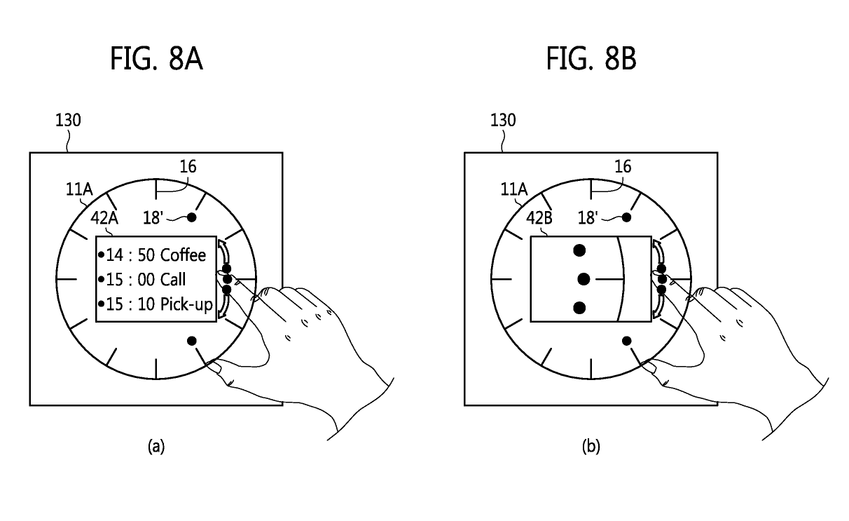

FIG. 7A through 9 are diagrams illustrating a method of displaying a scheduled event corresponding to an event display icon that a user wants to select when adjacent event display icons are selected by a user input at a time according to some embodiments of the inventive concept. For convenience' sake in the description, a user input is a touch input in the embodiments illustrated in FIGS. 7A through 9, but the inventive concept is not restricted to the current embodiments.

Referring to FIGS. 7A and 7B, when a plurality of event display icons 18′ or 23′ are displayed adjacent to one another in a narrow area on the watch screen 11A or 11C, it may be hard for a user to select exactly one icon among a plurality of the event display icons 18′ or 23′. Referring to FIGS. 8A and 8B, when at least one among the event display icons 18′ is selected by the user, a pop-up window 42A or 42B may be displayed on the display 130.

The pop-up window 42A or 42B may be displayed by a different touch input. For instance, when a touch input for selecting one among the event display icons 18′ or 23′ is referred to as a first input, a touch input for displaying the pop-up window 42A or 42B may be referred to as a second input. While the first input is a relatively short touch, the second input may be a relatively long touch.

The pop-up window 42A or 42B may display scheduled events corresponding to the event display icons 18′ in an enlarged manner. As shown in FIGS. 7A and 8A, the pop-up window 42A includes scheduled events corresponding to the adjacent event display icons 18′. As shown in FIGS. 7B and 8B, the pop-up window 42B may display a portion of the watch screen 11A, which includes the adjacent event display icons 18′, enlarged.

A user may scroll the pop-up window 42A or 42B or move a touch point to another event display ion on the watch screen 11A. In this case, a new event display icon besides the event display icons 18′ may be displayed in the pop-up window 42A or 42B. When a user selects one among the event display icons displayed in the pop-up window 42A or 42B, a scheduled event corresponding to the selected event display icon may be displayed in the pop-up window 42A or 42B.

Referring to FIGS. 8A through 9, when a user selects icon “15:10 Pick-up” among the adjacent event display icons displayed in the pop-up window 42A or 42B, a schedule GUI including a schedule display GUI 32B displaying an scheduled event “15:10-15:30 Pick-up” may be displayed on the display 130.

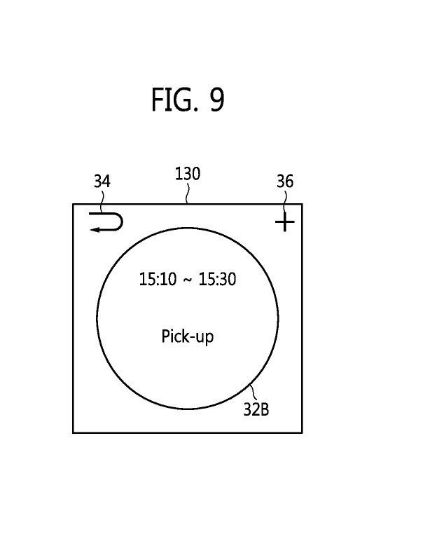

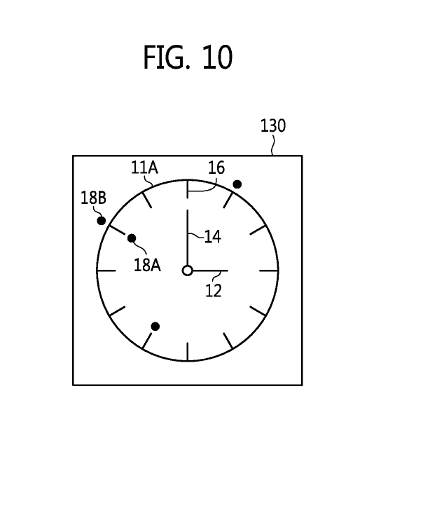

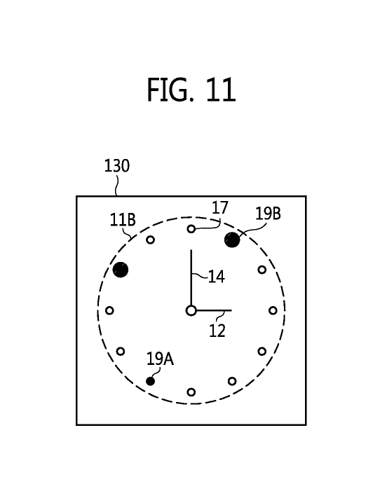

FIGS. 10 and 11 are diagrams of embodiments in which an event display icon belonging to a morning schedule and an event display icon belonging to an afternoon schedule are displayed to be distinguished from each other. Since an analog watch uses a 12-hour format, a gradation 16 or a circular symbol 17 indicates a time either in the morning or in the afternoon.

Referring to FIG. 10, event display icons include an event display icon 18A displayed inside the circle of the analog watch screen 11A and an event display icon 18B displayed outside the circle of the analog watch screen 11B. When the event display icon 18A belongs to one schedule between the morning schedule and the afternoon schedule, the event display icon 18B may belong to the other schedule. In other words, the event display icon 18A or 18B may be identified as being the morning schedule or the afternoon schedule according to the position where it is displayed.

Referring to FIG. 11, a morning schedule and an afternoon schedule may be distinguished from each other by the size, shape, color or brightness of event display icons 19A and 19B displayed on the analog watch screen 11B. When the event display icon 19A belongs to one between the morning schedule and the afternoon schedule, the event display icon 19B may belong to the other.

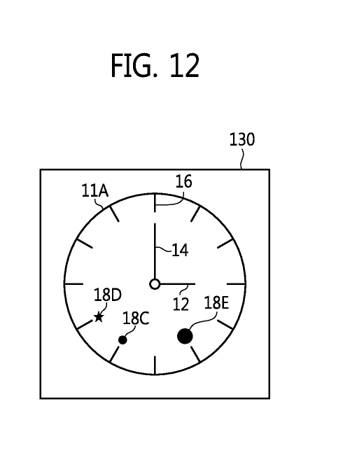

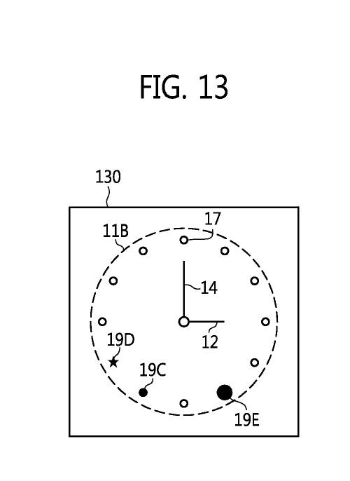

FIGS. 12 and 13 are diagrams of different displays of event display icons according to the categories of scheduled events according to some embodiments of the inventive concept. Referring to FIGS. 12 and 13, event display icons 18C through 18E or 19C through 19E may be displayed on the analog watch screen 11A or 11B in different forms (e.g., sizes, shapes or colors) according to categories which they fall into. Scheduled events may be categorized into an important schedule and a normal schedule, a regular schedule and a one-off schedule, or an official schedule and a private schedule; but the inventive concept is not restricted to the current embodiments.

Referring to FIGS. 12 and 13, the small dot event display icon 18C or 19C may fall into a first category, the star-shaped event display icon 18D or 19D may fall into a second category, and the large dot event display icon 18E or 19E may fall into a third category. Accordingly, a user can intuitively perceive the category which a scheduled event falls into based on the form of the event display icons 18C through 18E or 19C through 19E displayed on the analog watch screen 11A or 11B.

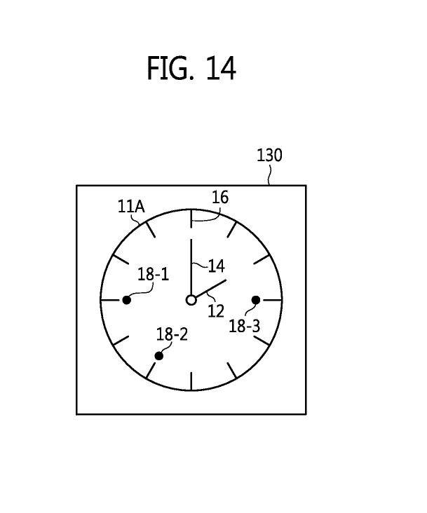

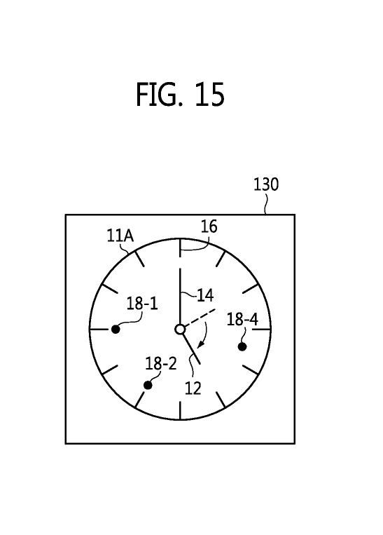

FIGS. 14 and 15 are diagrams of embodiments in which event display icons are updated over time. The wearable device 10 may delete an event display icon corresponding to a past event on the basis of the present time and may display an event display icon corresponding to a new scheduled event coming within a reference time (e.g., 12 or 24 hours) from the present time).

As shown in FIGS. 14 and 15, when the present time is five in the afternoon, an event display icon 18-3 corresponding to three in the afternoon in FIG. 14 may be deleted and an event display icon 18-4 corresponding to a new scheduled event coming within a reference time (e.g., 12 or 24 hours) from the current time may be displayed.

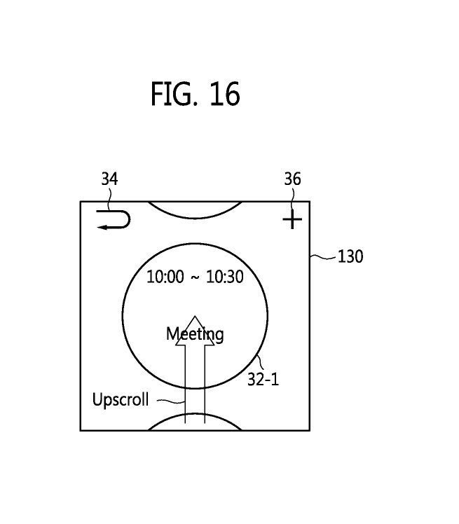

FIGS. 16 through 19 are diagrams of a schedule GUI that displays scheduled events according to some embodiments of the inventive concept. Referring to FIGS. 16 through 19, the wearable device 10 may change a schedule display GUI 32-1 or 32-3 into another schedule display GUI 32-2 or 32-4 according to a user input.

Referring to FIGS. 1, 16, and 17, the wearable device 10 may change the schedule display GUI 32-1 into another schedule display GUI 32-2 according to a first user input (e.g., “upscroll”). A user is allowed to check a schedule of one day by hour using “upscroll” or “downscroll”.

Referring to FIGS. 1, 18, and 19, the wearable device 10 may change the schedule display GUI 32-3 into another schedule display GUI 32-4 according to a second user input (e.g., “leftscroll”). Each of GUIs 38-1 and 38-2 displays a date. A user is allowed to check schedules by day using “leftscroll” or “rightscroll”.

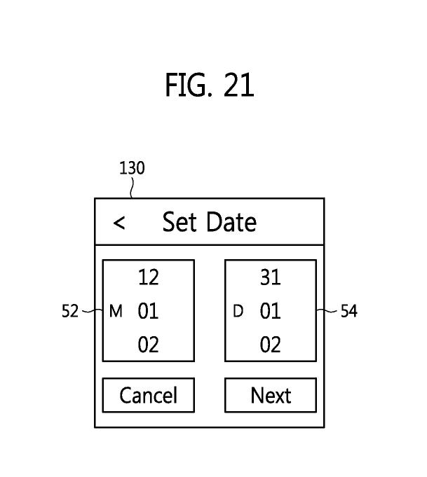

FIGS. 20 through 22 are diagrams illustrating a scheduled event creation process in a wearable device according to some embodiments of the inventive concept. Referring to FIG. 1 and FIGS. 20 through 22, when a user selects the event creation GUI 36 using the input device 150, the display 130 may display a “set date” GUI, as shown in FIG. 21, according to the control of the processor 110. The set date GUI may include a select-month GUI 52, a select-day GUI 54, a cancel GUI CANCEL, and a next GUI NEXT.

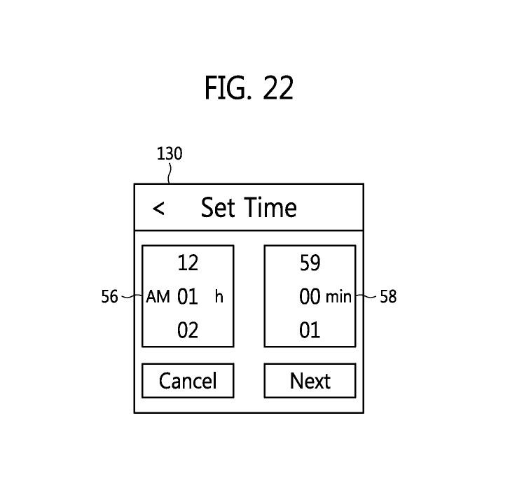

The user is allowed to set a date using the select-month GUI 52 and the select-day GUI 54 and to cancel the date using the cancel GUI CANCEL. When the user selects the next GUI NEXT, the display 130 displays GUIs 56 and 58 for setting a time according to the control of the processor 110. When the event creation process described with reference to FIGS. 21 and 22 is completed, the processor 110 creates a new event and may display an event display icon corresponding to the new scheduled event on a watch screen.

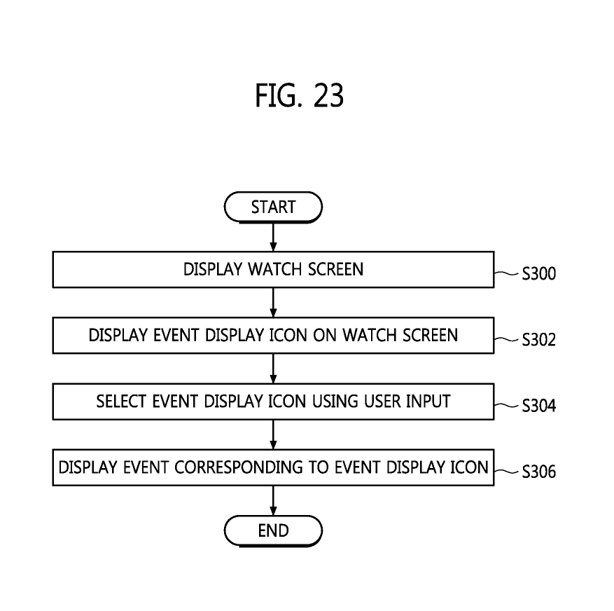

FIG. 23 is an operational flowchart associated with the embodiments illustrated in FIGS. 5 and 6. Referring to FIGS. 1 through 6 and FIG. 23, the wearable device 10 may display the watch screen 11A, 11B, or 11C on the display 130 according to the control of the processor 110 in operation S300 and may display the event display icon 18, 19, or 23 on the watch screen 11A, 11B, or 11C in operation S302. When the event display icon 18, 19, or 23 is selected by a user input in operation S304, the wearable device 10 may display a scheduled event corresponding to the selected event display icon 18, 19, or 23 on the display 130 according to the control of the processor 110 in operation S306.

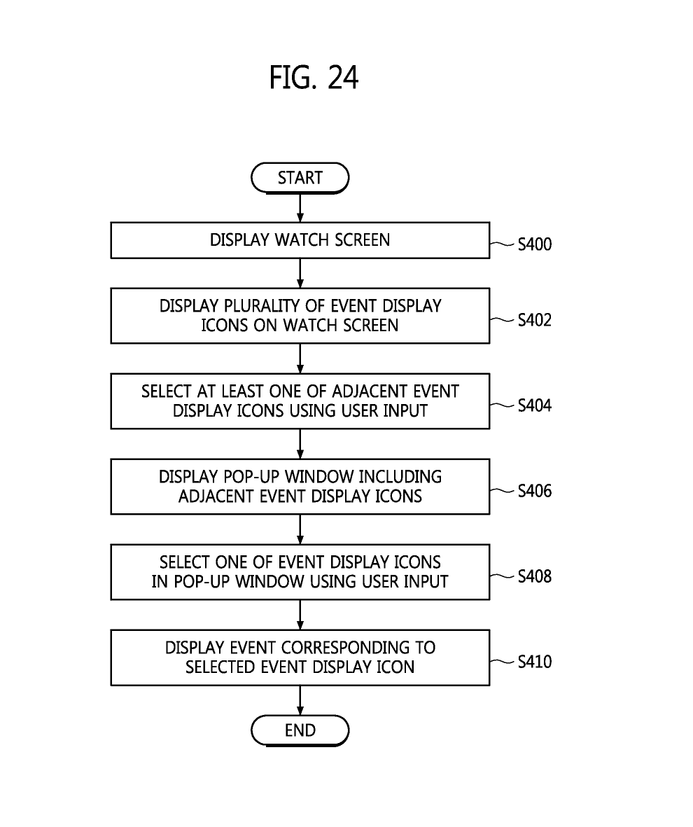

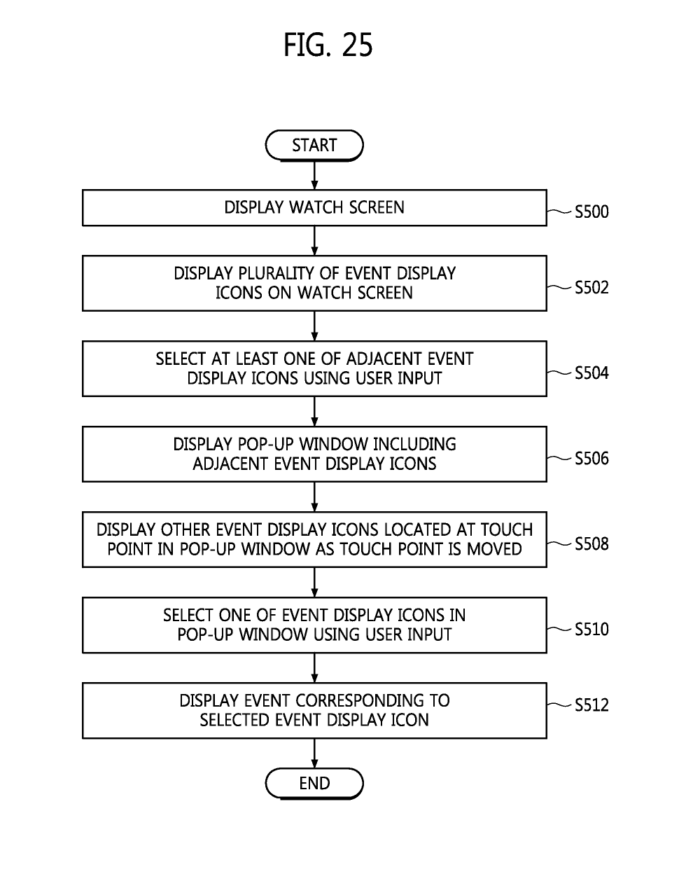

FIGS. 24 and 25 are operational flowcharts associated with the embodiments illustrated in FIGS. 7 through 9. Referring to FIGS. 1 through 4, FIGS. 7A through 9, and FIG. 24, the wearable device 10 may display the watch screen 11A, 11B, or 11C on the display 130 according to the control of the processor 110 in operation S400 and may display a plurality of the event display icons 18, 19, or 23 on the watch screen 11A, 11B, or 11C in operation S402.

When at least one of a plurality of adjacent event display icons is selected by a user input in operation S404, the wearable device 10 may display the pop-up window 42A or 42B including the adjacent event display icons on the display 130 according to the control of the processor 110 in operation S406. When one of the adjacent event display icons is selected in the pop-up window 42A or 42B by a user input in operation S408, the wearable device 10 may display a scheduled event corresponding to the selected event display icon on the display 130 according to the control of the processor 110 in operation S410.

Referring to FIGS. 1 through 4, FIGS. 7A through 9, and FIG. 25, the wearable device 10 may display the watch screen 11A, 11B, or 11C on the display 130 according to the control of the processor 110 in operation S500 and may display a plurality of the event display icons 18, 19, or 23 on the watch screen 11A, 11B, or 11C in operation S502.

When a user input is a touch input and at least one of a plurality of adjacent event display icons is selected by the touch input in operation S504, the wearable device 10 may display the pop-up window 42A or 42B including the adjacent event display icons on the display 130 according to the control of the processor 110 in operation S506. When a touch point is moved by a user, the wearable device 10 may display another event display icon located at the moved touch point in the pop-up window 42A or 42B according to the control of the processor 110 in operation S508.

When the user selects one of the plurality of event display icons in the pop-up window 42A or 42B in operation S510, the wearable device 10 may display a scheduled event corresponding to the selected event display icon on the display 130 according to the control of the processor 110 in operation S512.

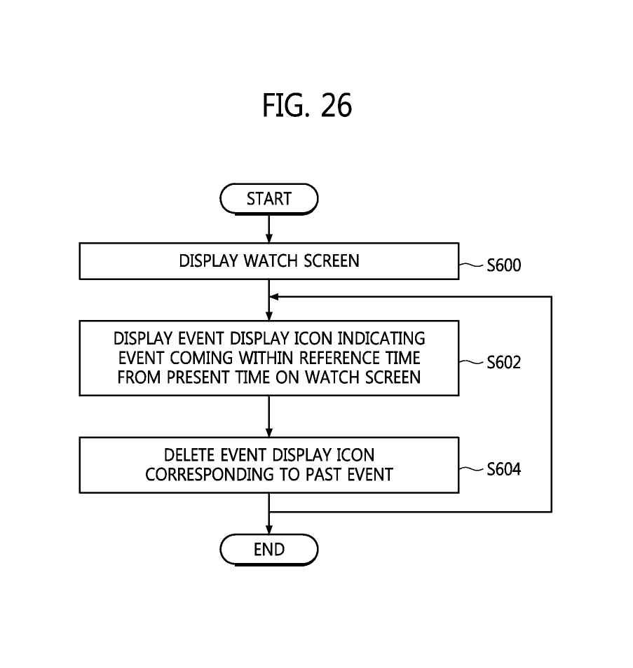

FIG. 26 is an operational flowchart associated with the embodiments illustrated in FIGS. 14 and 15. Referring to FIGS. 1 through 4 and FIGS. 14, 15, and 26, the wearable device 10 may display the watch screen 11A, 11B, or 11C on the display 130 according to the control of the processor 110 in operation S600 and may display event display icons 18-1, 18-2, and 18-3 corresponding to scheduled events coming within a reference time from the present time on the watch screen 11A, 11B, or 11C in operation S602.

Over time, the wearable device 10 may delete the event display icon 18-3 corresponding to a past event on the basis of the present time according to the control of the processor 110 in operation S604. Operations S602 and S604 may be repeated.

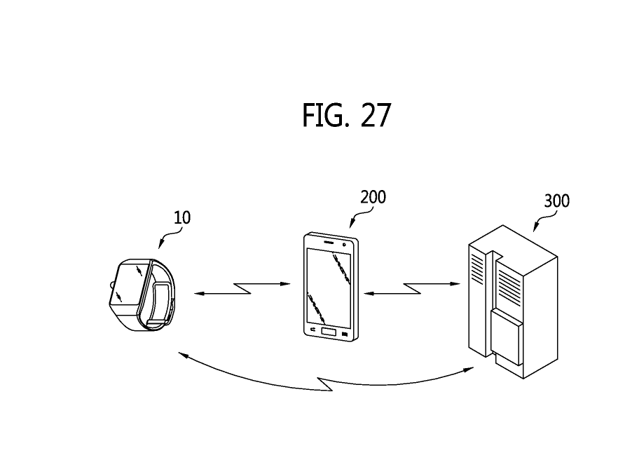

FIG. 27 is a diagram of a system, which performs a method of displaying a schedule in the wearable device 10, according to some embodiments of the inventive concept. Referring to FIG. 27, the wearable device 10 may communicate data with a portable terminal 200 and/or a server 300 through a wireless communication network. The wearable device 10 may synchronize a schedule with the portable terminal 200 and/or the server 300 to update the schedule.

The portable terminal 200 may control the operation of the wearable device 10 and may generate and transmit a schedule to the wearable device 10 and/or the server 300. The portable terminal 200 may be implemented as a smart phone, a tablet PC, a cellular phone, a personal digital assistant (PDA), a MID, an enterprise digital assistant (EDA), a personal navigation device or portable navigation device (PND), an IoT device, or an IoE device.

The server 300 may wirelessly communicate data with the wearable device 10 and/or the portable terminal 200 through a wireless network or a mobile communication network. The server 300 may store therein or in a database a schedule transmitted from the wearable device 10 and/or the portable terminal 200.

The server 300 may store an application program (i.e., an application or app) for executing a method of displaying a schedule in the wearable device 10. The server 300 may allow a user of the wearable device 10 to download the application program to the wearable device 10.

As described above, according to some embodiments of the inventive concept, a wearable device displays existence or non-existence of a schedule on a watch screen, thereby allowing a user to quickly and intuitively check the schedule. In addition, a schedule software module is easily and quickly entered in the wearable device, so that accessibility to a schedule is increased.

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A method of displaying a schedule including a scheduled event in a wearable device, the method comprising:
displaying a watch screen on a display of the wearable device; and
displaying an event display icon corresponding to the scheduled event on the watch screen.

2. The method of claim 1, further comprising displaying a description of the scheduled event corresponding to the event display icon when the event display icon is selected by a user input.

3. The method of claim 1, wherein the watch screen is an analog watch screen, and
wherein the event display icon is displayed at a time location on the analog watch screen that corresponds to a time of the scheduled event.

4. The method of claim 1, wherein the watch screen is an analog watch screen, and
wherein the event display icon is displayed on the analog watch screen in a different shape based on whether a time of the scheduled event is morning or afternoon.

5. The method of claim 1, wherein the watch screen is an analog watch screen,
wherein the event display icon is displayed inside of the analog watch screen when a time of the scheduled event corresponding to the event display icon is one of a morning time and an afternoon time,
wherein the event display icon is displayed outside of the analog watch screen when the time of the scheduled event is the other of the morning time and the afternoon time.

6. The method of claim 1, wherein the event display icon is displayed as a first type icon on the watch screen when a category of the scheduled event is a first category, and
wherein the event display icon is displayed as a second type icon on the watch screen when the category of the event is a second category.

7. The method of claim 1, wherein the schedule includes a plurality of scheduled events, and the displaying the event display icon on the watch screen comprises:
displaying a plurality of event display icons respectively corresponding to the plurality of scheduled events on the watch screen;
displaying a pop-up window when at least one of adjacent event display icons among the plurality of event display icons is selected by a user input; and
displaying the adjacent event display icons in the pop-up window.

8. The method of claim 7, further comprising displaying a description of a scheduled event corresponding to an event display icon which has been selected by a user input among the adjacent event display icons displayed in the pop-up window.

9. The method of claim 7, wherein the user input is a touch input using a touch screen, and when a touch point is moved by a user, an event display icon located at the moved touch point is displayed in the pop-up window.

10. The method of claim 1, further comprising deleting the event display icon displayed on the watch screen when a present time passes a time of the scheduled event corresponding to the event display icon.

11. The method of claim 1, wherein the schedule includes a plurality of scheduled evens, and wherein the displaying the event display icon on the watch screen comprises displaying first event display icons indicating first scheduled events among the plurality of scheduled events having times within a reference time range.

12. The method of claim 1, wherein the schedule is received from a portable terminal which can communicate with the wearable device.

13. The method of claim 1, wherein the schedule is created using a schedule software module installed in the wearable device.

14. The method of claim 1, further comprising performing a notification operation using the wearable device when a time of the scheduled event is within a reference time range.

15. A wearable device comprising:
a display configured to display a watch screen which includes an event display icon indicating a scheduled event;
a memory configured to store a schedule including the scheduled event; and
a processor configured to control operations of the display and the memory to display the event display icon on the watch screen, and to display a description of the scheduled event corresponding to the event display icon on the display when the event display icon is selected by a user input.

16. The wearable device of claim 15, wherein the watch screen is an analog watch screen, and the processor is configured to display the event display icon at a time location of the analog watch screen corresponding to a time of the scheduled event indicated by the even display icon.

17. The wearable device of claim 15, further comprising a radio frequency transceiver configured to receive the schedule from a portable terminal.

18. The wearable device of claim 15, further comprising a notifier configured to issue a notification of the scheduled event according a control of the processor when a time of the scheduled event is within a reference time range.

19. The wearable device of claim 15, wherein the wearable device is a smart watch.

20. A computer readable storage medium for storing a computer program for executing the method of claim 1.
